(19) United States
(12) Patent Application Publication
(10) Pub. No.: US 2013/0049704 A1
(43) Pub. Date: Feb. 28, 2013

(54) CHARGING APPARATUS AND CHARGING METHOD

(71) Applicants: Hideaki Andou, Ome-shi (JP); Yasuyuki Mizuura, Tokyo (JP)

(72) Inventors: Hideaki Andou, Ome-shi (JP); Yasuyuki Mizuura, Tokyo (JP)

(21) Appl. No.: 13/450,146

(22) Filed: Apr. 18, 2012

(30) Foreign Application Priority Data
Aug. 29, 2011 (JP) 2011-186117

(51) Int. Cl. H02J 7/00

(52) U.S. Cl. 320/162

(57) ABSTRACT

According to one embodiment, a charging apparatus includes a charger, a controller, and a switch. The charger is configured to charge a battery. The controller is configured to control a charge of the battery performed by the charger such that the charge is stopped when a battery capacity reaches a first capacity at a first charge mode and stopped when the battery capacity reaches a second capacity lower than the first capacity at a second charge mode. The switch is configured to execute processing which is concerned with switching between the first charge mode and the second charge mode in accordance with a record on the battery capacity.

### CROSS-REFERENCE TO RELATED APPLICATIONS

This application is based upon and claims the benefit of priority from prior Japanese Patent Application No. 2011-186117, filed Aug. 29, 2011, the entire contents of which are incorporated herein by reference.

### FIELD

Embodiments described herein relate generally to a charging apparatus and a charging method for charging a battery.

### BACKGROUND

When a battery is kept in a state where a remaining capacity thereof is close to 100% for a long time, the life of the battery is shortened. In order to prevent the life of a battery from being shortened, switch from a 100% charge mode, where charge is stopped when a remaining battery capacity reaches 100%, to an 80% charge mode, where charge is stopped when a remaining battery capacity reaches 80%, is practiced.

For the sake of the switch between the 100% charge mode and the 80% charge mode, a user must personally start an application. If a user is not aware of a feature of the 80% charge mode, and the state close to a fully charged state is kept for a long time with an AC adapter connected, the chargeable battery capacity will be decreased. Also, when a user who frequently uses a battery has set the 80% charge mode in the hope of extending the life of the battery, the user cannot make use of the battery by the 20% rest.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing one example of a structure of the charging apparatus according to the embodiments.

FIG. 2 is an exemplary block diagram showing one example of a system configuration of the charging apparatus according to the embodiments.

FIG. 3 is an exemplary block diagram showing a configuration for prompting for the change from the 100% charge mode to the 80% charge mode, or automatically changing from the 80% charge mode to the 100% charge mode.

FIG. 4 shows an exemplary setting window for switching between the 100% charge mode and the 80% charge mode.

FIG. 5 shows an exemplary pop-up window for prompting for the switch from the 100% charge mode to the 80% charge mode.

FIG. 6 shows an exemplary pop-up window for informing a user that the 80% charge mode has been switched with the 100% charge mode.

FIG. 7 is an exemplary flow chart showing the processing steps which are executed by a 100% charge mode determination module each time the remaining capacity [%] is informed after the 80% charge mode has been switched with the 100% charge mode or after activation of a computer after shipment.

FIG. 8 is an exemplary flow chart showing the processing steps which are executed by the 100% charge mode determination module each time the remaining capacity [%] is informed after the data indicative of a determination date and time is stored in reference date and time data.

FIG. 9 is an exemplary flow chart showing the processing steps which are executed by an 80% charge mode determination module each time the remaining capacity [%] is informed under the 80% charge mode.

### DETAILED DESCRIPTION

Various embodiments will be described hereinafter with reference to the accompanying drawings.

In general, according to one embodiment, a charging apparatus comprises a charger, a controller, and a switch. The charger is configured to charge a battery. The controller is configured to control a charge of the battery performed by the charger such that the charge is stopped when a battery capacity reaches a first capacity at a first charge mode and stopped when the battery capacity reaches a second capacity lower than the first capacity at a second charge mode. The switch is configured to execute processing which is concerned with switching between the first charge mode and the second charge mode in accordance with a record on the battery capacity.

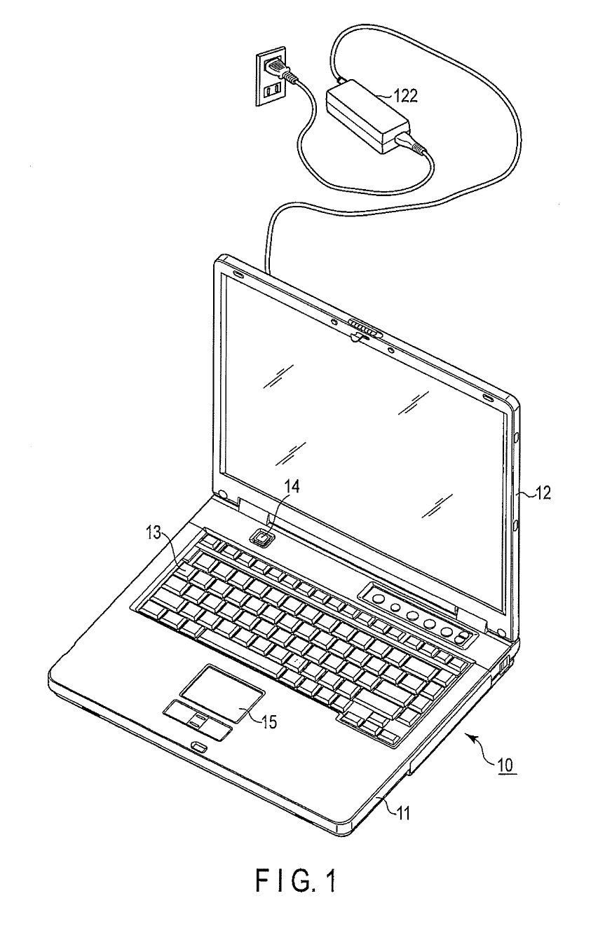

First, with reference to FIG. 1, a structure of the charging apparatus according to an embodiment will be described. The charging apparatus is realized as, for example, a portable personal computer 10 of a notebook type that can be driven by a battery. FIG. 1 is a frontal perspective view of the computer 10 with a display unit opened. The computer 10 comprises a computer main body 11 and the display unit 12. The display unit 12 incorporates a display apparatus comprising a liquid crystal display (LCD) 16.

The display unit 12 is supported by the computer main body 11 and attached to the computer main body 11 such that the display unit 12 can rotate between an open position where an upper face of the computer main body 11 is exposed and a closed position where the upper face of the computer main body 11 is covered with the display unit 12. The computer main body 11 comprises a housing having a thin box shape. On the upper face of the computer main body 11, a keyboard 13, a power supply switch 14 for powering on/off the computer 10, and a touch pad 15 are disposed.

Also, the computer main body 11 is provided with a power supply connector. The power supply connector 20 is provided at the side face, for example, the left side face, of the computer main body 11. To this power supply connector, an external power supply apparatus is detachably connected. As the external power supply apparatus, an AC adapter 122 may be employed. The AC adapter 122 is a power supply apparatus which converts a commercial power supply (AC power) to a DC power.

The power supply connector comprises a jack, to which a power supply plug drawn from the external power supply apparatus such as the AC adapter can be detachably connected. Furthermore, a battery 17 is provided in the computer main body 11. The battery 17 is detachably attached to, for example, the rear end portion of the computer main body 11.

The computer 10 is driven by the power from the external power supply apparatus or the power from the battery 17. When the external power supply apparatus is connected to the power supply connector of the computer 10, the computer 10 is driven by the power from the external power supply apparatus. Also, the power from the external power supply apparatus can as well be utilized for charging the battery 17. Charge of the battery 17 is carried out not only in a period during which the computer 10 is powered on, but also in a period during which the computer 10 is powered off. When the external power supply apparatus is not connected to the power supply connector of the computer 10, the computer 10 is driven by the power from the battery 17.

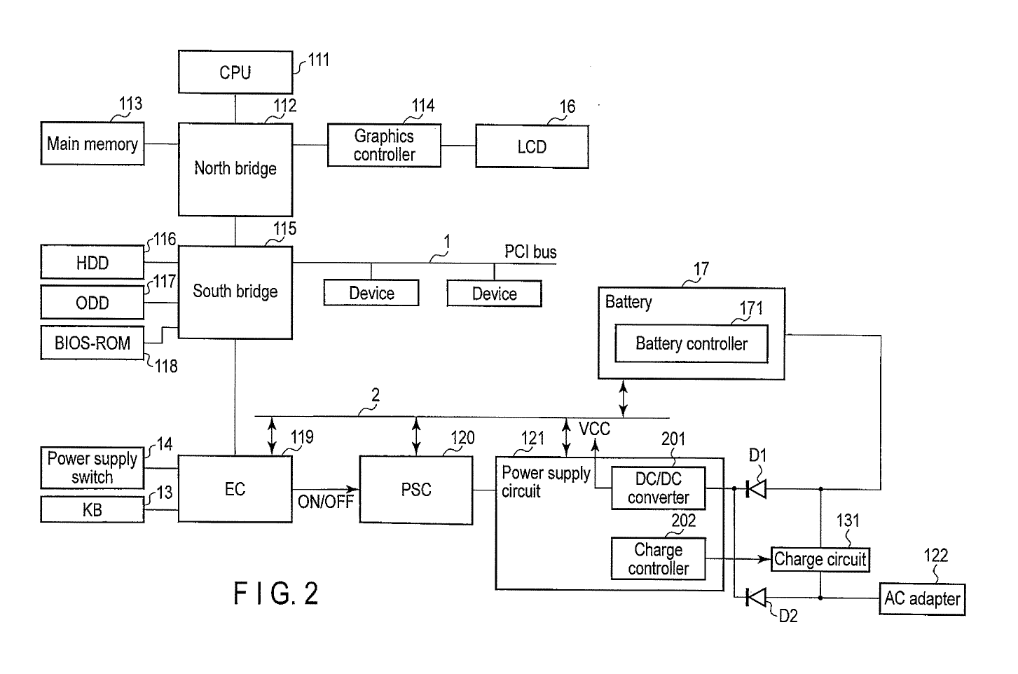

FIG. 2 shows a system configuration of the computer 10. The computer 10 comprises a CPU 111, a north bridge 112, a main memory 113, a graphics controller 114, a south bridge 115, a hard disk drive (HDD) 116, an optical disk drive (ODD) 117, a BIOS-ROM 118, an embedded controller (EC) 119, a power supply controller (PSC) 120, a power supply circuit 121, an AC adapter 122, etc. The AC adapter 122 is used as the aforementioned external power supply apparatus.

The CPU 111 is a processor which controls the operation of each component of the computer 10. This CPU 111 executes a variety of software, for example, an operating system (OS) and a variety of application programs, which are loaded from the HDD 116 into the main memory 113. Also, the CPU 111 executes a basic input output system (BIOS) stored in the BIOS-ROM 118 which is a nonvolatile memory. The BIOS is a system program for hardware control.

The north bridge 112 is a bridge device connecting a local bus of the CPU 111 with the south bridge 115. Also, the north bridge 112 includes a function of executing communication with the graphics controller 114. Further, the north bridge 112 comprises a built-in memory controller which controls the main memory 113. The graphics controller 114 is a display controller which controls the LCD 16 used as a display monitor of the computer 10.

The south bridge 115 is connected to a PCI bus 1 and executes communication with each device on the PCI bus 1. Also, the south bridge 115 comprises a built-in integrated drive electronics (IDE) controller or a serial ATA controller for controlling the hard disk drive (HDD) 116 and the optical disk drive (ODD) 117.

The EC 119, the power supply (PSC) controller 120, the power supply circuit 121 and the battery 17 are connected with each other through a serial bus 2, such as an I²C bus or a low pin count (LPC) bus. The embedded controller (EC) 119 is a power supply management controller for executing power management of the computer 10 and realized as, for example, a one-chip microcomputer comprising a built-in keyboard controller for controlling a keyboard (KB) 13, the touchpad 15, etc. The EC 119 has a function of powering on/off the computer 10 in response to the user's operation of the power supply switch 14. The control of powering on/off the computer 10 is executed by the cooperative action of the EC 119 and the power supply controller (PSC) 120. Upon receipt of an ON signal transmitted from the EC 119, the power supply controller (PSC) 120 controls the power supply circuit 121 to power on the computer 10. Also, upon receipt of an OFF signal transmitted from the EC 119, the power supply controller (PSC) 120 controls the power supply circuit 121 to power off the computer 10. The EC 119, the power supply controller (PSC) 120 and the power supply circuit 121 are operated by the power from the battery 17 or the AC adapter 122 even in a period during which the computer 10 is powered off.

The power supply circuit 121 generates an operation power supply for each component through the use of the power from the battery 17 attached to the computer main body 11 or the power from the AC adapter 122 connected as the external power supply to the computer main body 11. When the AC adapter 122 is connected to the computer main body 11, the power supply circuit 121 uses the power from the AC adapter 122 to generate an operation power supply for each component as well as to charge the battery 17 by turning a charge circuit 131 on. The battery 17 is connected to a power supply input terminal of the power supply circuit 121 via a diode D1. Similarly, the AC adapter 122 is connected to the power supply input terminal of the power supply circuit 121 via a diode D2. The charge circuit 131 is connected between, for example, an anode of the diode D2 and an anode of the diode D1. The charge circuit 131 charges the battery 17 by use of the power from the AC adapter 122 under the control of the power supply circuit 121. The charge circuit 131 comprises, for example, switch circuits, etc. that can be turned on/off by a control signal from the power supply circuit 121. When the AC adapter 122 is connected to the computer main body 11, charge of the battery 17 is carried out until the capacity of the battery 17 reaches a predetermined reference capacity.

The power supply circuit 121 comprises a DC/DC converter 201 and a charge controller 202. The DC/DC converter 201 generates a power VCC of a target direct current voltage as an operation power supply, by converting an input direct current voltage, which is input to the power supply input terminal, to the target direct current voltage. The charge controller 202 controls the charge circuit 131. When the AC adapter 122 is detached, the charge of the battery 17 is terminated at the same time.

The battery 17 comprises a plurality of secondary batteries and a battery controller 171.

The battery controller 171 includes data indicative of the temperature characteristics and the cycle characteristics of the secondary batteries, and calculates a remaining capacity [%] in the unit of percentage in accordance with the environment and the historical records of a battery pack. The remaining capacity [%] is a value representing the ratio between a current capacity and a chargeable capacity in percentages. The battery controller 171 transmits information on the remaining capacity in response to the request from the charge controller 202 or an operating system. It is noted that a remaining battery capacity is synonymous with a content of a battery.

At the time of charging the battery, two charge modes are available, namely, a 100% charge mode and an 80% charge mode. Under the 100% charge mode, charge is stopped when the remaining battery capacity reaches 100%. Under the 80% charge mode, charge is stopped when the remaining battery capacity reaches 80%. The computer includes a function of prompting a user to change from the 100% charge mode to the 80% charge mode, or automatically changing from the 80% charge mode to the 100% charge mode.

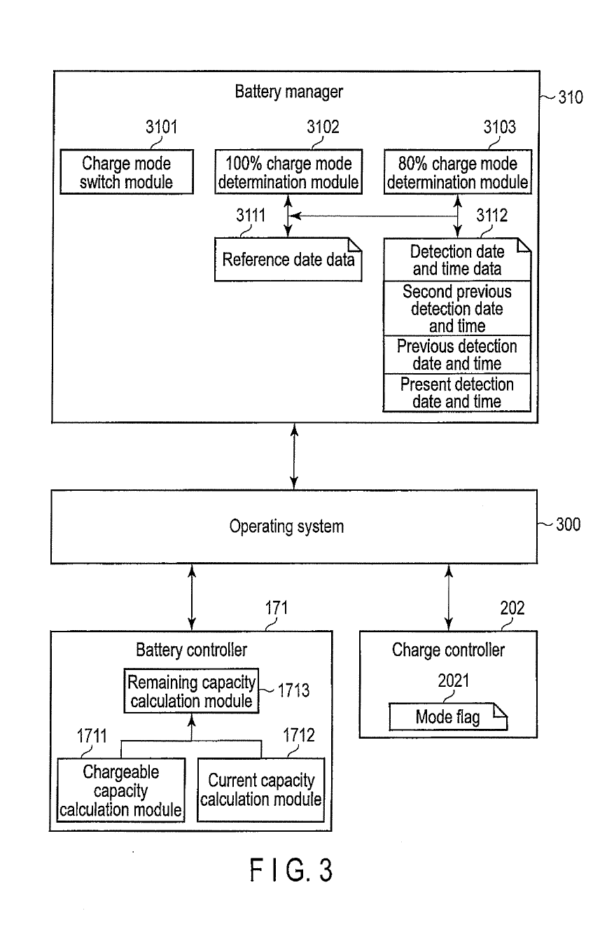

FIG. 3 is a block diagram showing a configuration for prompting for the change from the 100% charge mode to the 80% charge mode, or automatically changing from the 80% charge mode to the 100% charge mode.

An operating system 300 and a battery manager 310 are programs loaded into a main memory and executed by a CPU. The battery manager 310 comprises a charge mode switch module 3101, a 100% charge mode determination module 3102, an 80% charge mode determination module 3103, etc.

The battery controller 171 comprises a chargeable capacity calculation module 1711, a current capacity calculation module 1712, a remaining capacity calculation module 1713, etc. The chargeable capacity calculation module 1711 calculates a chargeable capacity [mAh] of the secondary batteries in the battery 17 in accordance with the environment and the historical records of the battery pack. The current capacity calculation module 1712 measures and integrates the inflow current and the outflow current of the secondary batteries to calculate a current capacity [mAh]. The remaining capacity calculation module 1713 calculates a value in the unit of percentage, which represents the ratio between the chargeable capacity [mAh] calculated by the chargeable capacity calculation module 1711 and the current capacity [mAh] calculated by the current capacity calculation module 1712.

The operating system 300 periodically makes an inquiry to the battery controller 171 about a remaining charge amount [%]. Upon inquiry from the operating system, the battery controller 171 calculates the remaining capacity [%]. When the remaining capacity [%] is changed, the operating system 300 informs the battery manager 310.

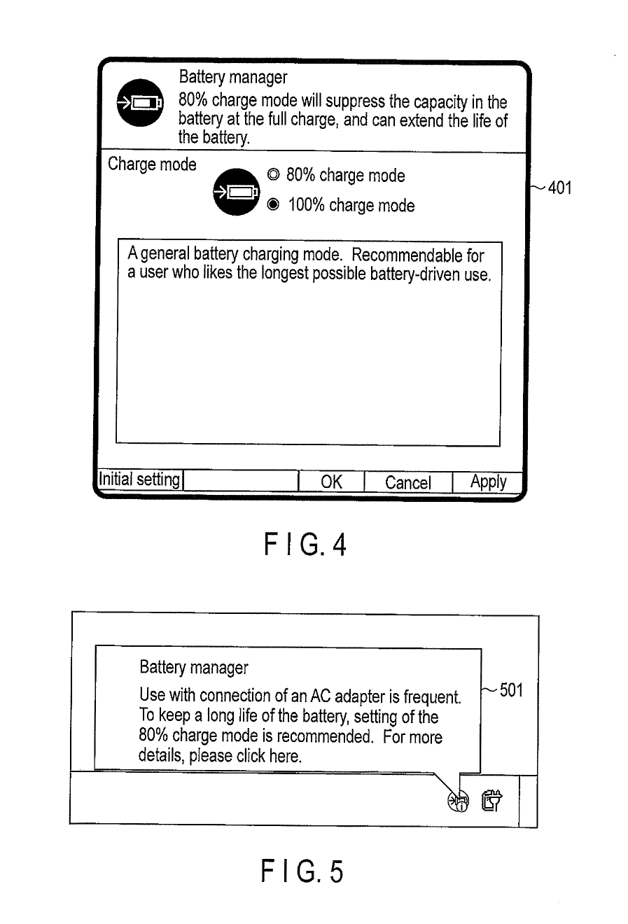

The charge mode switch module 3101 executes the processing of switching between the 100% charge mode and the 80% charge mode. The charge mode switch module 3101 displays a setting window 401, shown in FIG. 4, on the display screen of the LCD 16. Thereafter, the charge mode switch module 3101 switches between the 100% charge mode and the 80% charge mode, in accordance with the operation of the setting window 401 by the user. When the charge modes are switched, the charge mode switch module 3101 rewrites a value stored in a mode flag 2021 in the charge controller 202 to a value which accord with the charge mode. The charge controller 202 executes charging of the battery with the charge mode according to the value recorded in the mode flag 2021.

The 100% charge mode determination module 3102 determines whether or not to prompt for the switch from the 100% charge mode to the 80% charge mode, in accordance with the remaining capacity [%] and a reference date and time which is indicated by reference date and time data 3111 when the charge mode is the 100% charge mode. The reference date and time data 3111 contains data indicative of a date and time on which the determination about a remaining capacity [%] having exceeded 90% is first made after the switch from the 80% charge mode to the 100% charge mode, or data indicative of a date and time on which the determination about a remaining capacity [%] having exceeded 90% is first made since the activation after shipment of the computer. At the time of the shipment, the charge mode is set to the 100% charge mode. Thus, the data indicative of the date and time, on which the determination about a remaining capacity [%] having exceeded 90% is first made since the activation after shipment of the computer, is stored.

When it is determined that the state where the remaining capacity [%] is 90% or greater has been maintained for two weeks or longer, the 100% charge mode determination module 3102 prompts for the switch from the 100% charge mode to the 80% charge mode. In order to prompt for the switch from the 100% charge mode to the 80% charge mode, the 100% charge mode determination module 3102 displays a pop-up window 501, shown in FIG. 5, on the display screen of the LCD 16. The pop-up window 501 shown in FIG. 5 mentions, “Use with connection of an AC adapter is frequent. To keep a long life of the battery, setting of the 80% charge mode is recommended. For more details, please click here.” When the pop-up window 501 is clicked (operated), the 100% charge mode determination module 3102 displays the setting window 401, shown in FIG. 4, on the display screen of the LCD 16.

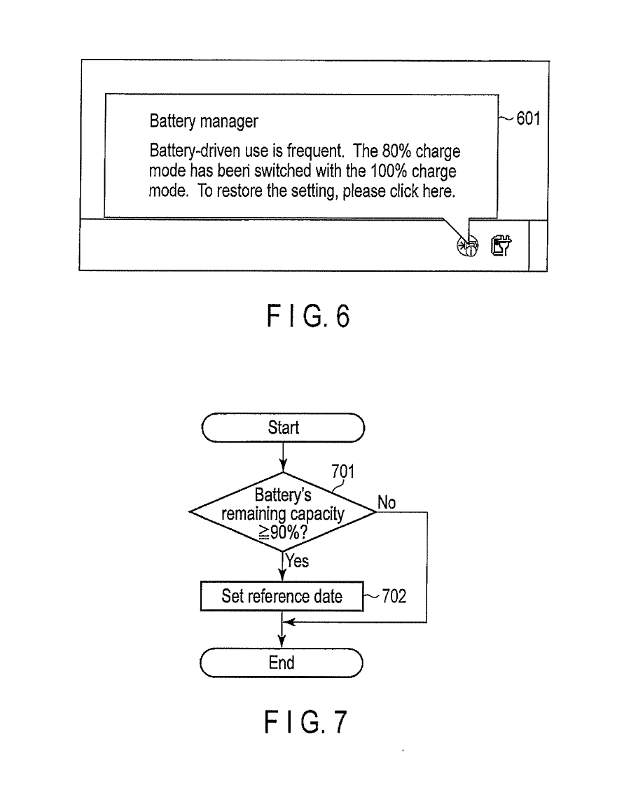

When the remaining capacity [%] is changed from 21% to 20%, the 80% charge mode determination module 3103 stores the date and time of change in detection date and time data 3112. The detection date and time data 3112 contains three detection date and time s. When the difference in period between a second previous detection date and time and a present detection date and time is a week or shorter, the 80% charge mode determination module 3103 automatically switches the 80% charge mode with the 100% charge mode. Thereafter, the 80% charge mode determination module 3103 informs the user that the automatic switch has been carried out. In order to inform the user that the automatic switch has been carried out, the 80% charge mode determination module 3103 displays a pop-up window 601, shown in FIG. 6, on the display screen of the LCD 16. The pop-up window 601 mentions, “Battery-driven use is frequent. The 80% charge mode has been switched with the 100% charge mode. To restore the setting, please click here.” When the pop-up window 601 is clicked (operated), the 80% charge mode determination module 3103 displays the setting window 401, shown in FIG. 4, on the display screen of the LCD 16.

Next, the processing executed by each of the 100% charge mode determination module 3102 and the 80% charge mode determination module 3103 will be described. First, the processing executed by the 100% charge mode determination module 3102 under the 100% charge mode will be described.

The 100% charge mode determination module 3102 executes the following processing each time the remaining capacity [%] is informed from the operating system 300 after the 80% charge mode has been switched with the 100% charge mode or after activation of a computer after shipment. The processing executed by the 100% charge mode determination module 3102 will be described with reference to the flowchart of FIG. 7.

Initially, each time the remaining capacity [%] is informed from the operating system 300, the 100% charge mode determination module 3102 determines if the informed remaining capacity [%] is 90% or greater (block 701). If it is determined that the informed remaining capacity [%] is not 90% or greater, the 100% charge mode determination module 3102 does not execute any processing. If it is determined that the informed remaining capacity [%] is 90% or greater, the 100% charge mode determination module 3102 stores data indicative of the determination date and time in the reference date and time data 3111 (block 702).

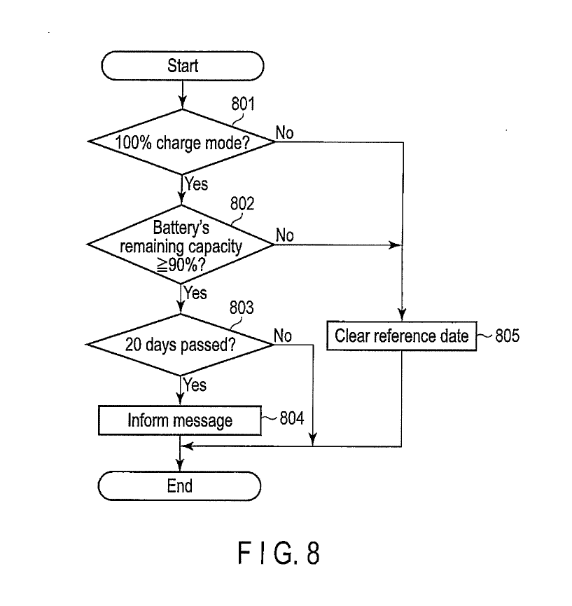

After storing the data indicative of the determination date and time in the reference date and time data 3111, the 100% charge mode determination module 3102 executes the following processing each time the remaining capacity [%] is informed from the operating system 300. The processing executed by the 100% charge mode determination module 3102 each time the remaining capacity [%] is informed from the operating system 300 after the data indicative of the determination date and time is stored in the reference date and time data 3111 will be described with reference to the flowchart of FIG. 8.

The 100% charge mode determination module 3102 determines if the current charge mode is the 100% charge mode (block 801). If it is determined that the current charge mode is not the 100% charge mode (NO in block 801), the 100% charge mode determination module 3102 clears the data stored in the reference date and time data 3111 (block 805). If it is determined that the current charge mode is the 100% charge mode (YES in block 801), the 100% charge mode determination module 3102 determines if the informed remaining capacity [%] is 90% or greater (block 802). If it is determined that the informed remaining capacity [%] is not 90% or greater (NO in block 802), the 100% charge mode determination module 3102 clears the data stored in the reference date and time data 3111 (block 805). If it is determined that the informed remaining capacity [%] is 90% or greater (YES in block 802), the 100% charge mode determination module 3102 calculates the difference in period between the date and time indicated by the reference date and time data 3111 and the date and time informed from the operating system 300. Then the 100% charge mode determination module 3102 determines if the difference is 20 days or longer (block 803). If it is determined that the difference is not 20 days or longer (NO in block 803), the 100% charge mode determination module 3102 terminates the processing. If it is determined that the difference is 20 days or longer (YES in block 803), the 100% charge mode determination module 3102 displays the pop-up window 501, shown in FIG. 5, on the display screen of the LCD 16.

With the above processing, the pop-up window for prompting the user to change from the 100% charge mode to the 80% charge mode can be displayed when the state where the remaining capacity [%] is 90% or greater is kept for a period of 20 days or longer. It is noted that the charge mode may automatically be switched from the 100% charge mode to the 80% charge mode when the state where the remaining capacity [%] is 90% or greater is kept for a period of 20 days or longer.

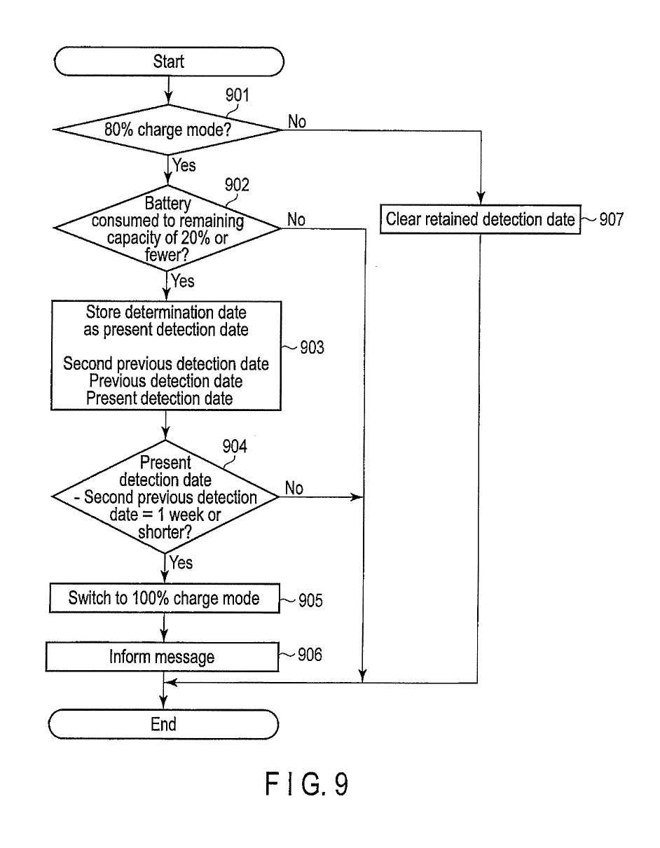

Next, the processing executed by the 80% charge mode determination module 3103 each time the remaining capacity [%] is informed from the operating system 300 under the 80% charge mode will be described. The processing executed by the 80% charge mode determination module 3103 will be described with reference to the flowchart of FIG. 9.

The 80% charge mode determination module 3103 determines if the current charge mode is the 80% charge mode (block 901). If it is determined that the current charge mode is not the 80% charge mode (NO in block 901), the 80% charge mode determination module 3103 clears the data in the detection date and time data 3112 (block 907). If it is determined that the current charge mode is the 80% charge mode (YES in block 901), the 80% charge mode determination module 3103 determines if the informed remaining capacity [%] has been changed from 21% to 20% (block 902). If it is determined that the informed remaining capacity [%] has not been changed from 21% to 20% (NO in block 902), the 80% charge mode determination module 3103 terminates the processing. If it is determined that the informed remaining capacity [%] has been changed to 20% (YES in block 902), the 80% charge mode determination module 3103 stores the data indicative of the determination date and time in block 902 in the detection date and time data 3112 as a present detection date and time (block 903). The 80% charge mode determination module 3103 calculates the difference (in period) between the present detection date and time and the second previous detection date and time (block 903). The 80% charge mode determination module 3103 determines if the calculated period is a week or shorter. If the calculated period is not a week or shorter (NO in block 904), the 80% charge mode determination module 3103 terminates the processing. If the calculated period is a week or shorter (YES in block 904), the 80% charge mode determination module 3103 rewrites the mode flag 2021 in the charge controller 202 to a value indicative of the 100% charge mode (block 905). The 80% charge mode determination module 3103 displays the pop-up window 601 shown in FIG. 6.

With the above processing, the 80% charge mode can automatically be switched with the 100% charge mode when the number of instances where the remaining capacity [%] is changed from 21% to 20% is indicated to be three times within a week. It is noted that the pop-up window for prompting the user to change from the 80% charge mode to the 100% charge mode may be displayed when the number of instances where the remaining capacity [%] is changed from 21% to 20% is indicated to be three times within a week.

In the above embodiment, the operating system 300 makes an inquiry to the battery controller 171 about the remaining capacity [%], and the battery controller 171 informs the operating system 300 about the remaining capacity [%]. However, it may be so configured that the battery controller 171 monitors the remaining capacity [%], and upon occurrence of change in the remaining capacity [%], the operating system 300 is informed from the battery controller 171.

Also in the above embodiment, the operating system 300 makes an inquiry to the battery controller 171 about the remaining capacity [%]. However, it may be so configured that the operating system 300 makes an inquiry to the battery controller about a chargeable capacity and a current capacity, and calculates the remaining capacity [%] in accordance with the chargeable capacity and the current capacity informed from the battery controller 171.

Also in the above embodiment, start and stop of the battery charge are controlled in accordance with the remaining battery capacity. However, start and stop of the battery charge may be controlled in accordance with the voltage of the battery instead of the remaining capacity. Also, the remaining capacity may be calculated from both the charged battery capacity and the voltage of the battery.

It is noted that the processing executed by the battery manager 310 according to the embodiment is realized by a computer program. Therefore, only by installing this computer program in a normal computer through a computer-readable storage medium, the same effect as in the embodiment can easily be realized. Also, this computer program can be executed not only on personal computers but also on electronic devices comprising a built-in processor.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A charging apparatus comprising:
a charger configured to charge a battery;
a controller configured to control a charge of the battery performed by the charger such that the charge is stopped when a battery capacity reaches a first capacity at a first charge mode and stopped when the battery capacity reaches a second capacity lower than the first capacity at a second charge mode; and
a switch configured to execute processing which is concerned with switching between the first charge mode and the second charge mode in accordance with a record on the battery capacity.

2. The apparatus of claim 1, wherein the switch is configured to execute processing which is concerned with switching from the first charge mode to the second charge mode when the battery capacity is kept at a third capacity for a predetermined time period, the third capacity is between the first capacity and the second capacity.

3. The apparatus of claim 2, wherein the processing which is concerned with the switching from the first charge mode to the second charge mode comprises displaying a pop-up window for prompting for switching from the first charge mode to the second charge mode.

4. The apparatus of claim 3, wherein the switch is configured to display a setting window for switching from the first charge mode to the second charge mode when the pop-up window is operated.

5. The apparatus of claim 1, wherein the switch is configured to execute processing which is concerned with switching from the second charge mode to the first charge mode upon occurrence of a predetermined number of instances where the battery capacity is a fourth capacity lower than the second capacity.

6. The apparatus of claim 5, wherein the processing which is concerned with the switching from the second charge mode to the first charge mode comprises switching from the second charge mode to the first charge mode.

7. The apparatus of claim 6, wherein the switch is configured to display a pop-up window on a display screen to inform that the second charge mode has been switched with the first charge mode, when the second charge mode is switched with the first charge mode.

8. The apparatus of claim 7, wherein the switch is configured to display information in the pop-up window when the pop-up window is operated, the information indicating that a setting window for switching from the first charge mode to the second charge mode will be displayed.

9. The apparatus of claim 1, wherein the battery capacity is a percentage value representing a quotient of a current battery capacity and a full charge battery capacity.

10. A charging method for charging a battery until a battery capacity reaches a first capacity at a first charge mode, and for charging the battery until the capacity of the battery reaches a second capacity lower than the first capacity at a second charge mode, the method comprising:
executing processing which is concerned with switching between the first charge mode and the second charge mode in accordance with a record on the battery capacity.

11. A computer-readable, non-transitory storage medium having stored thereon a computer program which is executable by a computer, the computer configured to charge a battery until a battery capacity reaches a first capacity at a first charge mode and to charge the battery until the battery capacity reaches a second capacity lower than the first capacity under at a second charge mode, the computer program controlling the computer to execute functions of:
executing processing which is concerned with switching between the first charge mode and the second charge mode in accordance with a record on the capacity in the battery.
